(19) United States
(12) Patent Application Publication
(10) Pub. No.: US 2009/0304175 A1
(43) Pub. Date: Dec. 10, 2009

(54) DRIVE SYSTEM AND METHOD FOR AN AUTOMATED SWITCH MATRIX

(75) Inventors: Sture Roos, Stockholm (SE); Johan Oberg, Stockholm (SE)

Correspondence Address: ALBIHNS AB, BOX 5581, Valhallavagen 117, STOCKHOLM, SE-114 85, SE

(73) Assignee: NORDIA INNOVATION AB, Stockholm (SE)

(21) Appl. No.: 11/573,102

(22) PCT Filed: Jul. 29, 2005
(86) PCT No.: PCT/IB2005/052562

§ 371 Date: Nov. 11, 2008

(30) Foreign Application Priority Data
Aug. 2, 2004 (SE) 0401981-6

(51) Int. Cl. H04M 3/00

(52) U.S. Cl. 379/325

(57) ABSTRACT

The invention relates to a drive means that implements a single electric motor arrangement (150) for use in automating cross-connect on a switch matrix board (100). The invention is particularly applicable to switch matrix boards used in automated cross-connect systems for automating cross-connects for telephone lines. In an embodiment of the invention, the drive means comprises preferably an electric stepper motor (150) that selectively moves itself on the switch matrix board to a position to make the selected cross-connect. A magnetic clutch assembly (200,300) is coupled to the motor (150) to enable it to move laterally across the board. Once in position, the clutch assembly (200,300) enables the motor to rotatively engage with a positioning screw 120 thereby causing displacement of the corresponding contact means (130) to establish the line cross-connect.

### FIELD OF THE INVENTION

The present invention relates generally to switch matrix boards for making cross-connects for telephone or data lines and, more particularly, to an improved drive system for the switch matrix boards that are suitable for use in automated cross-connect systems.

### BACKGROUND OF THE INVENTION

In a typical telecommunication network, the central office houses a telephone exchange to which subscriber home and business lines are connected to the network on what is called a local loop. Many of these connections to residential subscribers are typically made using a pair of copper wires, also referred to as a twisted pair, that collectively form a large copper network operated by the telecom provider. Within the central office the line connections between the exchange side and the subscriber side are terminated at a main distribution frame (MDF), which is usually the point where cross-connections between the subscriber lines and the exchange lines are made. Virtually all aspects of the telecommunication network are automated with the notable exception of the copper network. Management of the copper infrastructure is a highly labor intensive process that results in one of the most significant costs faced by telecommunication providers. This is because the central office made traditionally dispatches technicians to the MDF site to manually install cross-connects using jumper wires or to analyze or test the lines in the copper network.

As a result service providers have long desired to reduce the amount of labor required to maintain and manage copper infrastructure by automating the process of making, removing, or modifying cross-connects for line pairs in the MDF. A number of automated cross-connect solutions have been developed and marketed in recent years. Many of these products implement an automated switching matrix using electromechanical relays or robotic technologies to make the cross-connects. A major drawback with the use of electromechanical relays is that their physical size limits the capacity of the switch matrix. In other words, to handle more lines more relays must be added, which is generally very difficult given the space limitations of the matrix. Moreover, robotic solutions tend to exhibit reliability and maintenance issues over the long term that tend to increase costs. While the prior art solutions have existed for some time, none of them have been able to fulfill requirements for cost-effectiveness and scalability required by telecom service providers.

One type of switch matrix technology uses a plurality of mechanical sliding contact blocks or sledges that mechanically engage contact pads for performing cross-connects. This type of switch matrix is used in the Nexa™ Automated Cross-Connect System manufactured by Network Automation AB of Stockholm, Sweden. A more detailed description of the drive mechanism is described in Swedish patent application no. 0400095-6 and assigned to the present applicant. A switch matrix of this type is scalable and is capable of cross-connecting a number of input lines to a number of output lines. Although the switch matrix is typically configured for cross-connecting line pairs, it is possible to configure the switch matrix to connect any line in a set of input lines to any line in a set of output input lines to provide a so-called ‘any-to-any’ connectivity.

The switch matrix board comprises a plurality of electrically conducting contact pads that are formed into a printed circuit board (PCB). The contact pads are arranged into e.g. a plurality of longitudinal contact trains by which an electrical connection or cross-connect is made when a contact block is driven to mechanically engage over the contact pads. A pair of stationary stepper motors drives the contact blocks via a drive mechanism that includes a pair of top and bottom lateral positioning screws for displacing a lateral drive gear. The lateral drive gear is displaced to a position just in front of a selected of contact block positioning screw which it then engages and rotates to displace the contact block.

Although the contact blocks can be accurately displaced and positioned on the switch matrix, the drive arrangement is somewhat complicated leading to operating performances for displacing the sledges that are relatively slow. Furthermore, the control system of the drive mechanism is relatively complex since both lateral positioning screws must turn in precise synchronism in order maintain stationary rotation of the lateral drive gear. Furthermore, much of the energy is consumed in turning the multiple elements of the drive mechanism, which results in a much less efficient device. Additionally, it becomes increasing difficult to maintain synchronous rotation of the elements if any of the elements wear over time. Moreover, the use of two stepper motors on each switch matrix increases the overall cost of the system, which becomes increasingly significant in cross-connect systems employing tens or even hundreds of switch matrix boards.

U.S. Pat. No. 4,817,134 discloses another type of switch matrix that uses two motors for displacing a plurality of cross-connect shorting elements for connecting a set of line pairs within a single plane. The cross-connects on the switch matrix are performed using movable shorting elements to electrically connect a first set of line pairs to a second set of perpendicular oriented line pairs. The contact elements are moved into position by rotating positioning screws by two stepper motors operating in combination. The first stepper motor operates to turn a positioning screw that displaces a second stepper motor to a position in front of the selected shorting element positioning screw. The second stepper motor engages the positioning screw that displaces the shorting element to the cross-connect the line pair. The drive arrangement requires two stepper motors working in combination that are controlled by a relatively complicated control system resulting in increased complexity for the system.

In view of the foregoing, it is desirable to provide a drive mechanism for switch matrix with a drive mechanism that overcomes the previous disadvantages and provides and efficient device with improved performance with less control system complexity.

### SUMMARY OF THE INVENTION

Briefly described and in accordance with embodiments and related features of the invention, there is provided a method and system for automating a switch matrix board for cross-connecting telephone lines using drive means comprised of a single electric motor. An object of the invention is to overcome the disadvantages of the drive means in the prior art and to provide improved efficiency and performance with less cost and control complexity. In an embodiment of the invention, the drive means comprises preferably an electric stepper motor that selectively moves itself on the switch matrix board in order to accurately position itself to make the selected cross-connect. A clutch assembly, preferably a magnetic friction clutch assembly, is coupled to the motor to enable it to move laterally across the board. Once in position, the clutch assembly (200,300) enables the motor to rotatively engage with a positioning screw thereby displacing a contact means coupled to the positioning screw to slidably engage a set of contact pads associated with the line pair to make the cross-connect.

The switch matrix board comprises a plurality of electrically conducting contact pads (110) disposed on to which the lines are connected. Also included are a plurality of rotatable positioning screws that are coupled to the contact means (130) for displacing the contact means. In a first embodiment, the electric motor is preferably a stepper motor with a rotatable shaft that is coupled to a toothed lateral positioning gear that is rotatively engageable with a latitudinal gear track 190 spanning the width of the board for providing lateral movement for the motor. The motor shaft is also coupled to a drive gear for rotatively engaging the positioning screws. The clutch assembly is activated to a state that enables lateral movement of the motor and rotation and to another state to enable the drive gear to rotatively engage the selected positioning screw. All the while the lateral positioning gear remains on the latitudinal gear track at all times during the operation.

In a second embodiment, the clutch assembly operates similarly to move the motor laterally, however, upon engagement of the drive gear with the positioning screw, the clutch assembly displaces the lateral positioning gear from the latitudinal gear track. To move the motor to another position, the clutch assembly is activated to displace the lateral positioning gear back on the latitudinal gear track where the motor is activated to produce movement. A position detection system can be implemented in the embodiments to enable accurate displacement of the motor and the contact means on the switch matrix board.

### BRIEF DESCRIPTION OF THE DRAWINGS

The invention, together with further objectives and advantages thereof, may best be understood by reference to the following description taken in conjunction with the accompanying drawings in which:

FIG. 1 depicts an exemplary switch matrix board implementing the drive mechanism of the present invention;

FIG. 2 shows a end view of the single motor drive arrangement and switch matrix board operating in accordance with a first embodiment of the present invention;

FIG. 3 is a side view of the drive arrangement operating to laterally move the motor across the switch matrix board in accordance with the first embodiment;

FIG. 4 is a side view of the drive arrangement operating to rotate the positioning screw in accordance with the first embodiment;

FIG. 5 shows a side view of the drive arrangement operating to laterally move the motor in accordance with a second embodiment of the invention;

FIG. 6 shows the drive assembly of the second embodiment operating to rotate the positioning screw in accordance with a second embodiment;

FIG. 7 is a exemplary illustration of an automated cross-connect system installed within a central office MDF cabinet implementing the switch matrix boards of the present invention; and

FIG. 8 illustrates an exemplary depiction of an automated cross-connect system utilizing the present invention.

### DETAILED DESCRIPTION OF THE INVENTION

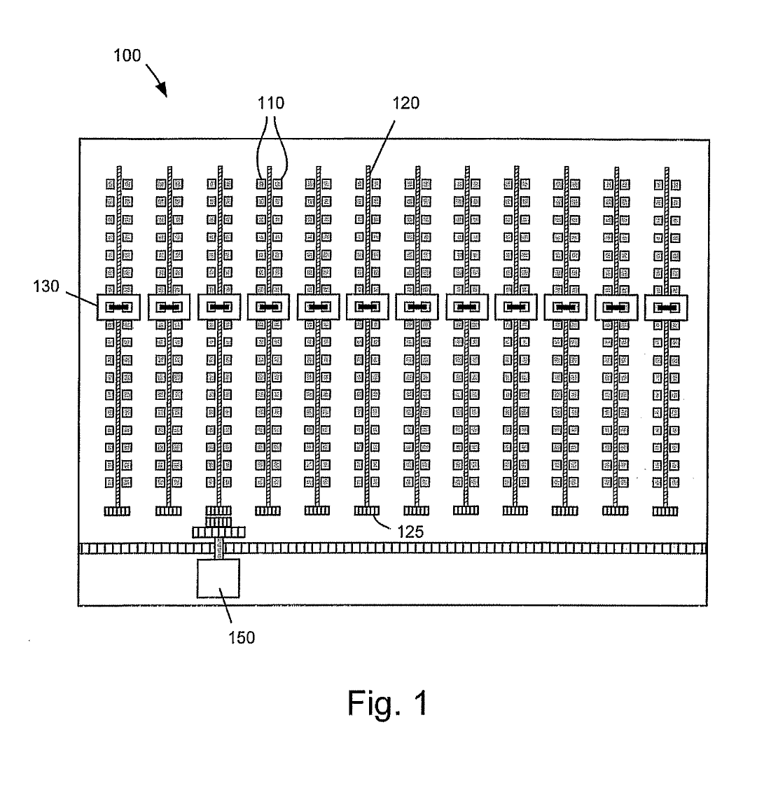

FIG. 1 depicts an exemplary switch matrix board 100 capable of using the drive mechanism of the present invention. The switch matrix 100 is configured for cross-connecting a number of input line pairs to a number of output line pairs. The switch matrix board comprises a plurality of electrically conducting contact pads 110 that are formed into a printed circuit board (PCB). The contact pads are arranged into a plurality of longitudinal contact trains by which an electrical connection between them is made when a contact block or sledge 130 mechanically engages and make contact with the contact pads 110. The contact pads are connected through the PCB to internal conductor layers that interconnect with other contact pads. It should be noted that although the switch matrix of the embodiment is configured for cross-connecting line pairs, it is possible for the matrix to connect any line in a set of input lines to any line in a set of output lines in a so-called any-to-any configuration. Each of the contact sledges 130 are displaced longitudinally along the axis of the positioning screws 120 by rotating them via positioning screw gear 125. Rotating the positioning screw 120 in the opposite direction reverses the direction of contact sledge 130, where the rotating action is performed by a movable single motor drive means arrangement.

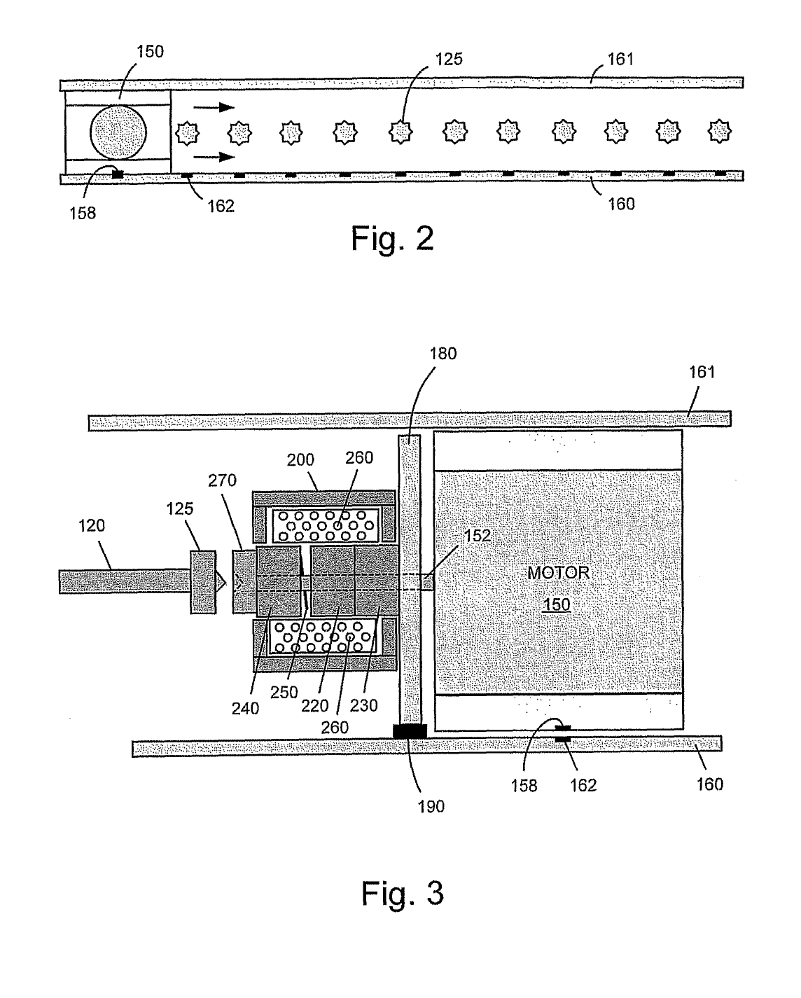

FIG. 2 shows a end view of the single motor drive arrangement and switch matrix board operating in accordance with a first embodiment of the present invention. The invention is applicable for use in and automated cross-connect system such as the Nexa™ Automated Cross-Connect System. The motor arrangement 150 is shown in a configuration that enables it to be propelled back and forth laterally to position itself in front of a particular positioning screw gear 125. As the drive arrangement traverses sideways it is guided in the lateral direction by a base plate (160) and top a plate (161) that sandwich the switch matrix board 100. The motor can be accurately aligned with the positioning screw gear 125 by using a position detection system that includes a motor position contact 158 and a series of board position contacts 162 embedded into the base guide plate (160) PCB. For example, using a positioning system gives the drive system the capability to provide both accurate lateral positioning and rotational engagement with a selected positioning screw gear 125 with a single motor arrangement. The position detection system also enables detection of the position of the contact sledges 130 on the switch matrix board for precise positioning. Preferably, the drive arrangement the motor is a stepper motor but other types of motors can be used.

FIG. 3 is a side view of the drive arrangement operating in accordance with the first embodiment. The figure illustrates the operation of the drive arrangement as configured for lateral motion of the motor. In the embodiment, the drive arrangement includes a friction clutch 200 driven by preferably an electric stepper motor 150 that is operable to provide both lateral positioning and rotating action for the sledge positioning screw 120. The motor 150 is coupled through shaft 152 that rotates a center friction drum 220 within the clutch assembly. The center friction drum 210 is fixed to the motor shaft 210 and always rotates with the motor. To provide lateral movement, a concentrically shaft mounted spring 250, anchored at on end by a front drum 240, applies pressure to the center friction drum 220 to push up against a rear friction drum 230 causing it to rotate. The rear friction drum 230 is coupled to a lateral positioning gear 180, both of which freely rotate on shaft 210 and are caused to rotate when the center friction drum 220 frictionally engages it in rotation. When this happens, the lateral positioning gear 180, having its teeth engaged with a latitudinal gear track 190, begins to turn thereby moving the drive assembly. This is the default state when the clutch is not activated since spring 250 causes the lateral positioning gear 180 to turn with the motor.

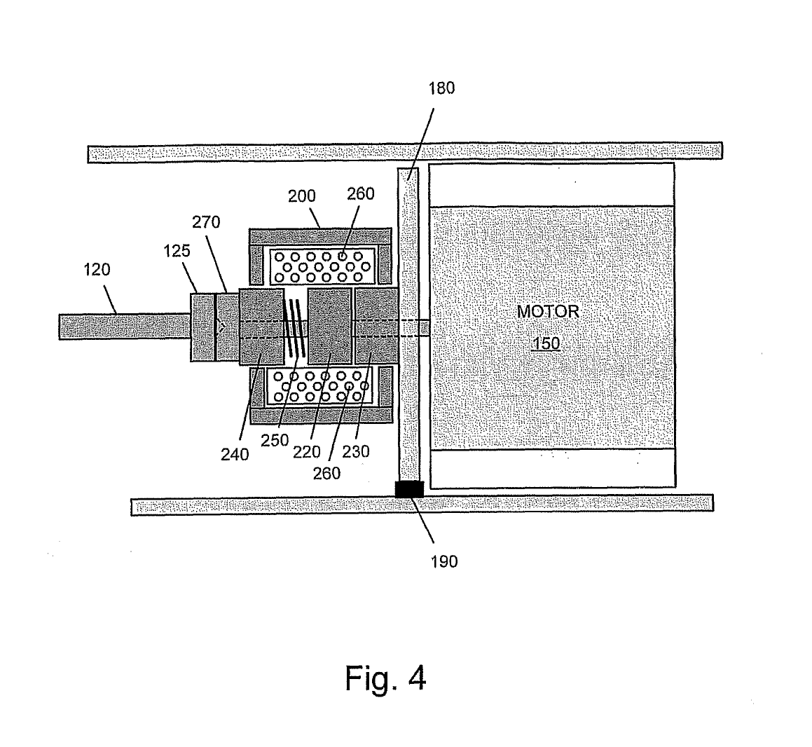

FIG. 4 is a side view of the drive arrangement operating to rotationally drive the positioning screw 120 that ultimately results in the movement of the contact sledge 130.

In this configuration, the friction clutch 200 is activated by allowing current flow through the coils 260 which has the effect of causing the center friction drum 220 to slide slightly to the left thereby opening a small gap between the center friction drum 220 and the rear friction drum 230. The gap causes the lateral movement of the drive assembly to disengage. At the same time, the sliding movement causes a front drive gear 270 at the end of the shaft 210 to frictionally engage the front face of the positioning screw gear 125 thereby rotating the positioning screw 120. The front drive gear 270 and the front drum 240 are fixed to the motor shaft and spin with it accordingly.

At the end of the screw gear 125 is a centering cone that fits snuggly into a corresponding conical recess in the front drive gear 270 to provide a self-centering mechanism when the drive assembly engages the positioning screw 120. Centering is important since any off-center engagement would cause an undesirable torque on the drive assembly and possibly hindering proper operation. When properly centered the drive assembly can rotate the positioning screw 120 without the need for additional support against torsional forces.

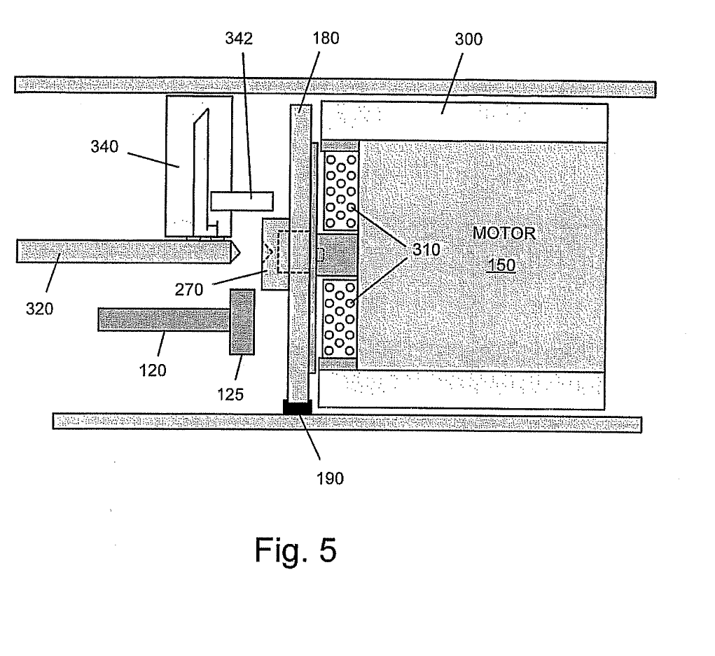

FIG. 5 shows a side view of the drive arrangement operating to laterally move the motor across the switch matrix board in accordance with a second embodiment of the invention. Here the lateral positioning gear 180 is positioned to ride on the latitudinal gear track 190 when lateral movement of the drive assembly is desired. The lateral positioning gear 180 is coupled to the shaft of the motor 150 and rotates with the motor. A displacement clutch assembly 300 is used to move the lateral positioning gear 180 on and off the gear track 190. The clutch activated when there is current flow through coil 310 to ‘pull’ the lateral positioning gear 180 onto the gear track 190. When the motor 150 is activated the lateral positioning gear 180 rotates to laterally move the drive assembly to the desired location.

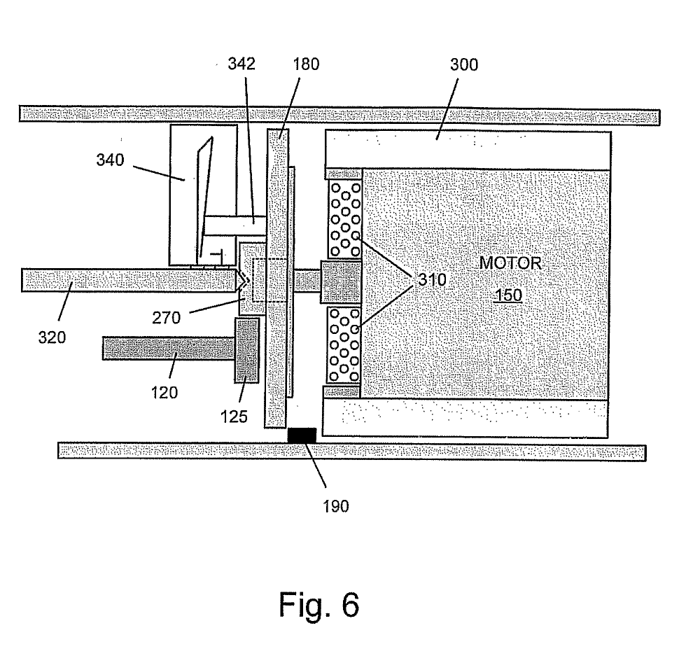

FIG. 6 shows the drive assembly of the second embodiment when the clutch 300 is configured to rotate the positioning screw 120. When the clutch 300 is activated the lateral positioning gear 180 is ‘pushed’ off of the gear track 190 and into an engagement posture with the positioning screw 120. This happens when the current flow in coil 310 induces a force to repel the magnet 184 attached to the lateral positioning gear 180. As a result this causes the front drive gear 270 to engage with the teeth of the positioning screw gear 125 which at the same time receives a conically tipped centering rod 320 into the conical recess in the front drive gear 270 to provide self-centering. The use of the centering rod 320 is necessary for support since the drive gear 270 drives the positioning screw gear 125 from an ‘off-center’ position creating lateral torsional forces on the drive assembly.

At the same time the lateral positioning gear 180 preferably activates a line disconnect contact 340 by pushing in a contact pin 342 to separate the contacts. The line disconnect is used for electrically disconnecting the line associated with the contact sledge in order to prevent signals carried on the line from disturbing other lines handled by the switch matrix during operation. Although it is preferable to include the line disconnect contact 340 feature it is an optional feature and not necessary for the operation of the drive assembly. In this embodiment the entire positioning gear 180 is displaced off and on the gear track 190 so there is a possibility that the teeth of the corresponding components do not mesh due to misalignment when trying to return the positioning gear on the gear track, however, this can be corrected by rotating the positioning gear slightly.

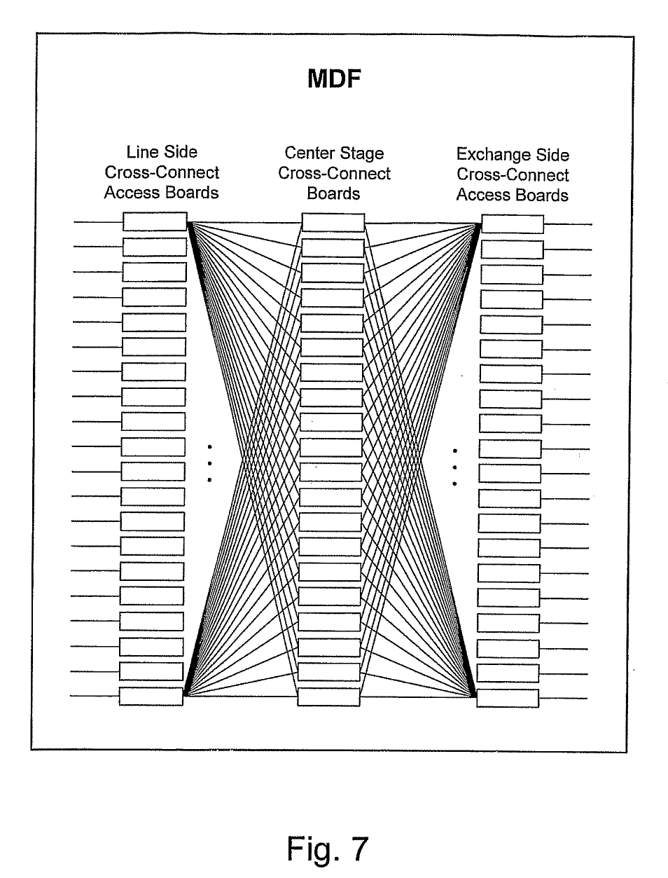

FIG. 7 is a schematic illustration of the exemplary Nexa™ automated cross-connect system installed within a central office MDF cabinet implementing the switch matrix boards of the present invention. Shown in the figure are a plurality of modular cross-connect boards that contain the switch matrix boards as presently described. The MDF comprises a column of cross-connect access boards that are connected to the line side termination blocks to which the incoming lines from the subscribers are terminated within the MDF. Similarly the column of cross-connect access boards are attached to the termination blocks on the exchange side. The figure also shows the use of an optional center stage interconnected with the subscriber and exchange side cross-connect boards. The center stage comprises a plurality of cross-connect boards to which additional cross-connect boards can be added in modular fashion as the capacity of the MDF increases.

In this example, the modular cross-connect boards are inserted into the MDF termination block. The cross-connect board is inserted into the slot of a KRONE LSA-Plus termination block that is commonly used in many central office MDFs. The skilled person in the art will appreciate that the described cross-connect boards can be adapted to mate with different configurations of termination blocks with relatively minor modifications to the connector arrangement. The interconnected modular cross-connect boards are installed as part of the Nexa™ system into distribution frame locations within a telecommunication network to provide remotely automated cross-connect functionality.

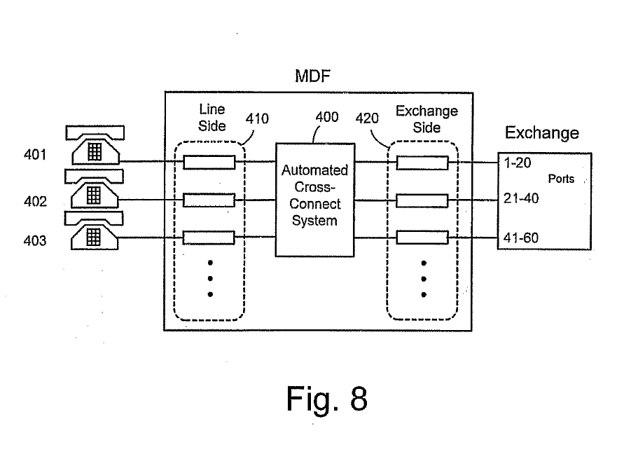

FIG. 8 is an illustration of the automated cross-connect system installed within a exemplary telephone network and operating in accordance with the invention. The automated cross-connect system 400 enables so-called any-to-any connections from any of the subscriber line pairs to any physical (or logical) port on the exchange. By way of example, subscriber lines (401, 402, 403) are connected at the MDF via connector blocks 410 on the line side. The output lines from connector blocks 410 are coupled to the cross-connect system 400, which establishes on demand cross-connections to any of ports on the central office exchange via the exchange side connector blocks 420. The switch matrix connector boards are connected to the connector blocks (not shown) and interfaces with the cross-connect system. By way of example, when a command is given to the system to make, remove or modify a cross-connect, the corresponding contact sledge associated with the selected line on a selected switch matrix board is automatically repositioned by the system software in accordance with the technique described in the invention.

The foregoing description of the preferred embodiments of the invention has been presented for purposes of illustration and description. It is not intended to be exhaustive or to limit the invention to the precise forms disclosed, since many modifications or variations thereof are possible in light of the above teaching. Accordingly, it is to be understood that such modifications and variations are believed to fall within the scope of the invention. The embodiments were chosen to explain the principles of the invention and its practical application, thereby enabling those skilled in the art to utilize the invention for the particular use contemplated. Still, it should be noted that the inventive concept can be applied to any application that would benefit from automated cross-connections such as patch panels used in connecting data communications equipment such as a LANs to the other networks or electronic systems. Moreover, it is to be appreciated that the invention can be operated independently on a switch matrix board or in cooperation with automated cross-connect system. It is therefore the intention that the following claims not be given a restrictive interpretation but should be viewed to encompass variations and modifications that are derived from the inventive subject matter disclosed.

1. Drive means for automating cross-connects on a switch matrix board, wherein said drive means comprising:
an electric motor comprising a shaft, that is selectively positionable on the switch matrix board for driving a selected cross-connect;
clutch means coupled to the electric motor for enabling the motor to move itself to a selected position, wherein the clutch means is arranged in a first state to connect the shaft of the motor to a lateral extending gear track and, while in the selected position, engages the motor to drive the cross-connects, wherein the clutch means is arranged in a second state to connect the drive shaft of the motor to a position screw of the matrix board; and
activating means arranged to move the clutch means between the first state and the second state.

2. The drive means according to claim 1, wherein the activating means is a coil arranged to move the clutch means when current flows through the coil.

3. The drive means according to claim 1, wherein the drive means is operable with the switch matrix board comprising:
electrically conducting contact pads disposed on said switch matrix apparatus and connected to said lines;
contact means for slidably engaging with said contact pads for cross-connecting the lines;
positioning screws coupled to the contact means for displacing said contact means, whereby the motor moves into position to engage and rotate the selected positioning screw to displace the contact means to establish the cross-connect.

4. The drive means according to claim 1, wherein the electric motor is preferably a stepper motor comprising the rotatable shaft that is coupled to a toothed lateral positioning gear that is rotatively engageable with the latitudinal gear track for providing lateral movement of the motor, and wherein the shaft is also coupled to a drive gear for rotatively engaging the positioning screws.

5. The drive means according to claim 4, wherein the clutch means is activated to provide lateral movement of the motor and rotation of the selected positioning screw by the motor by retaining the lateral positioning gear on the latitudinal gear track at all times.

6. The drive means according to claim 5, wherein the clutch means is activated to provide lateral movement of the motor engaging the lateral positioning gear on the latitudinal gear track, and wherein the drive gear rotatively engages the positioning screw by disengaging the lateral positioning gear from the latitudinal gear track.

7. The drive means according to claim 4, wherein the drive gear rotatively engages with the positioning screw with the aid of a self-centering rod.

8. The drive means according to claim 1, wherein the clutch means is preferably an electro-magnetically operated clutch.

9. The drive means according to claim 1, wherein the drive means includes position detection means for detecting the lateral position of the electric motor and the position of the contact means on the switch matrix board.

10. The drive means according to claim 1, wherein the drive means include a line disconnect means for electrically disconnecting the line associated with the contact sledge in order to prevent signals carried on the line from disturbing other lines handled by the switch matrix during operation.

11. A method of automating a cross-connect on a switch matrix board using drive means comprising a movable electric motor comprising a shaft, that is selectively positionable on the switch matrix board, a clutch means coupled to the electric motor for enabling movement of the motor and for establishing the cross-connect; and activating means to operate the clutch means, the method comprising the steps of:
using the motor to position itself at a selected position on the switch matrix board for making the selected cross-connect via the clutch means, wherein the clutch means is arranged in a first state to connect the shaft of the motor to a lateral extending gear track of the switch matrix board;
using the motor to drive and establish the cross-connect via the clutch means, wherein the clutch means is arranged in a second state to connect the shaft of the motor to a position screw of the switch matrix board; and
activating the activating means to move the clutch means between the first state and the second state.

12. The method according to claim 11, wherein the activating means is a coil and is activated by allowing current flow through the coil.

13. The method according to claim 11, wherein the drive means is operable on the switch matrix board that comprises:
electrically conducting contact pads disposed on said switch matrix apparatus and connected to said lines;
contact means for slidably engaging with said contact pads for cross-connecting the lines;
positioning screws coupled to the contact means for displacing said contact means, whereby the motor is moved into position to rotatively engage the selected positioning screw to displace the contact means to establish the cross-connect.

14. The method according to claim 11, wherein the electric motor is preferably a stepper motor comprising the rotating shaft that is coupled to a toothed lateral positioning gear that is rotatively engageable with the latitudinal gear track for providing lateral movement of the motor, and wherein the shaft is also coupled to a drive gear for rotatively engaging the positioning screws.

15. The method according to claim 14, wherein the clutch means is activated to provide lateral movement of the motor and rotation of the selected positioning screw by the motor by retaining the lateral positioning gear on the latitudinal gear track at all times.

16. The method according to claim 14, wherein the clutch means is activated to provide lateral movement of the motor engaging the lateral positioning gear on the latitudinal gear track, and wherein the drive gear rotatively engages the positioning screw by disengaging the lateral positioning gear from the latitudinal gear track.

17. The method according to claim 11, wherein the drive gear rotatively engages with the positioning screw with the aid of a self-centering rod.

18. The method according to claim 11, wherein the clutch means is preferably an electro-magnetically operated clutch.

19. The method according to claim 11 wherein the drive means includes position detection means for detecting the lateral position of the electric motor and the position of the contact means on the switch matrix board.

20. The method according to claim 11, wherein the drive means include a line disconnect means for electrically disconnecting the line associated with the contact sledge in order to prevent signals carried on the line from disturbing other lines handled by the switch matrix during operation, said line disconnect means is activated when the positioning screws are rotatively engaged.

21. The method according to claim 11, wherein the drive means is controlled by software commands by control means located on the switch matrix board.

22. An automated cross-connect system comprising a switch matrix board for use in cross-connecting telephone lines, said switch matrix board comprising:
electrically conducting contact pads disposed on said switch matrix apparatus and connected to said lines;
positioning screws coupled to contact means that slidably engage with said contact pads for cross-connecting the lines; and
drive means for rotating the positioning screws for displacing said contact means comprising:
a electric motor comprising a shaft, that selectively moves itself into position on the switch matrix board;
clutch means coupled to said motor for enabling movement of the motor, wherein the clutch means is arranged in a first state to connect the shaft of the motor to a lateral extending gear track of the switch matrix board; and enables rotative engagement of the selected positioning screw for displacing the associated contact means to establish the cross-connect, wherein the clutch means is arranged in a second state to connect the shaft of the motor to a position screw of the matrix board; and
activating means arranged to move the clutch means between the first state and the second state.

23. An automated cross-connect system according to claim 22, wherein activating means is a coil arrange to move the clutch means when current flows through the coil.

24. An automated cross-connect system according to claim 22, wherein the drive means includes position detection means for detecting the lateral position of the electric motor and the precise position of the contact means on the switch matrix board.

25. An automated cross-connect system according to claim 22, wherein the switch matrix board is incorporated into modular cross-connect boards and connected to a plurality of connector blocks within a central office main distribution frame (MDF) operating with a telecommunication network.
